(19) United States
(12) Patent Application Publication
(10) Pub. No.: US 2023/0394412 A1
(43) Pub. Date: Dec. 7, 2023

(54) SYSTEMS AND METHODS FOR STRATEGIC INVESTMENT DECISIONS ON HIGHWAY IMPROVEMENT PROJECTS

(71) Applicant: UNIVERSITY OF SOUTH FLORIDA, Tampa, FL (US)

(72) Inventor: Mouyid ISLAM, Tampa, FL (US)

(21) Appl. No.: 18/034,372

(22) PCT Filed: Oct. 28, 2021
(86) PCT No.: PCT/US2021/057051

§ 371 Date: Apr. 27, 2023

Related U.S. Application Data
(60) Provisional application No. 63/106,541, filed on Oct. 28, 2020.

(51) Int. Cl. G06Q 10/0637; G06Q 50/08

(52) U.S. Cl. CPC G06Q 10/0637; G06Q 50/08

(57) ABSTRACT

A method analyzing benefits and cost for a roadway improvement project includes obtaining definitions of a plurality of emphasis areas associated with a highway safety plan, and obtaining crash data associated with each of the plurality of emphasis areas. The crash data can include a plurality of crashes, a location of each crash, functional class associated with each crash, and injury levels associated with each crash. The method further includes obtaining countermeasure and Crash Modification Factor (CMF) data associated with each emphasis area, obtaining spatial assignments for each crash, determining a frequency of crashes for at least one injury level for each emphasis area, determining a plurality of costs associated with each countermeasure in the countermeasure and CMF data, a benefit cost ratio for each countermeasure in the countermeasure and CMF data associated with the emphasis area, and generating a first user interface configured to render a table or a visualization based at least on at least one emphasis area, the set of countermeasures, and the benefit cost ratio associated with the at least one countermeasure.

### CROSS-REFERENCE TO RELATED APPLICATIONS

This patent application is based on, claims priority to and incorporates by reference in its entirety U.S. Provisional Patent Application Ser. No. 63/106,541 filed on Oct. 28, 2020, entitled “Systems and Methods for Strategic Investment Decisions On Highway Improvement Projects.”

### STATEMENT OF GOVERNMENT SUPPORT

This invention was made with government support under grant/contract number 018-04, awarded by the U.S. Department of Transportation (DOT). The Government may have certain rights in this invention.

### BACKGROUND

To select a particular highway project from a set of projects geared towards safety is important for any highway agencies It can be important when the highway agency selects and implements a project from other competing projects considering the limited resources. Any highway improvement projects can be very cost, time and technology/labor intensive. Considering the competing nature of these highway projects, selecting a project based on an objective matrix can play an important role for a highway agency. Quantitative safety is now being recognized as an essential element in project selection processes at the planning phase. Quantitative evaluation of safety performance of particular roadway facilities, for example, segments and intersections, is critical to understand where safety concerns need to be addressed on a priority basis. A process that provides guidance to agencies for implementing appropriate safety improvements to a prioritized set of locations is critical to safety programming based on a systemic approach.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In accordance with an embodiment, a system including at least one processor, and a non-transitory computer-readable medium in communication with the at least one processor. The at least one processor can be configured to execute instructions embodied in the computer-readable medium to perform operations including obtaining definitions of a plurality of emphasis areas associated with a highway safety plan, obtaining crash data associated with each of the plurality of emphasis areas, the crash data comprising a plurality of crashes, a location of each crash, functional class associated with each crash, and injury levels associated with each crashes; obtaining spatial assignments for each crash in the plurality of crashes, determining a frequency of crashes for fatal and serious injury crash levels for each emphasis area by functional class based on the crash data associated with each emphasis area, determining a mileage of crashes fatal and serious injury crash levels for each emphasis area by functional class based on the crash data associated with each emphasis area, determining at least one estimate of change in crashes expected after implementation of at least one countermeasure of a plurality of countermeasures, wherein each emphasis area is associated with a set of countermeasures from the plurality of countermeasures, determining a plurality of costs associated with the plurality of countermeasures, determining, for each emphasis area, a benefit cost ratio for each countermeasure in the set of countermeasures associated with the emphasis area, and generating a user interface configured to render at least one of a table or a visualization based at least in part on at least one emphasis areas, the set of countermeasures associated with the at least one countermeasure, and the benefit cost ratio associated with the at least one countermeasure.

In accordance with an embodiment, a method analyzing benefits and cost for a roadway improvement project includes obtaining, via at least one computing device, definitions of a plurality of emphasis areas associated with a highway safety plan, and obtaining, via the at least one computing device, crash data associated with each of the plurality of emphasis areas. The crash data can include a plurality of crashes, a location of each crash, functional class associated with each crash, and injury levels associated with each crash. The method further includes obtaining, via the at least one computing device, countermeasure and Crash Modification Factor (CMF) data associated with each emphasis area, obtaining, via the at least one computing device, spatial assignments for each crash in the plurality of crashes, determining, via the at least one computing device, a frequency of crashes for fatal and serious injury crashes for each emphasis area by functional class based on the crash data associated with each emphasis area, determining, via the at least one computing device, a plurality of costs associated with each countermeasure in the countermeasure and CMF data, determining, for each emphasis area, via the at least one computing device, a benefit cost ratio for each countermeasure in the countermeasure and CMF data associated with the emphasis area, and generating, via the at least one computing device, a first user interface configured to render at least one of a table or a visualization based at least on at least one emphasis area, the set of countermeasures associated with the at least one emphasis area, and the benefit cost ratio associated with the at least one countermeasure.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 provides one example illustration of a computing environment employed in a networked environment according to various embodiments of the present disclosure;

FIG. 2 illustrates a method for determining benefits and costs for a roadway improvement project using a decision support tool according to various embodiments of the present disclosure;

FIG. 3 illustrates an example user interface of a decision support tool according to various embodiments of the present disclosure;

FIG. 4 illustrates and example user interface of decision support tool, the user interface configured to receive and display project information for a roadway project according to various embodiments of the present disclosure;

FIG. 5 illustrates an example user interface of a decision support tool, the user interface configured to provide crash data for emphasis areas and functional classes/facility type according to various embodiments of the present disclosure;

FIGS. 6A and 6B illustrate an example use interface of a decision support tool, the user interface configured to provide information regarding countermeasures according to various embodiments of the present disclosure;

FIGS. 7A and 7B illustrate example user interfaces of a decision support tool, the user interfaces configured to receive input and display an analysis of combinations of emphasis areas, countermeasures and functional classes/facility types for a roadway project according to various embodiments of the present disclosure;

FIG. 8 illustrates an example user interface of a decision support tool, the user interface configured to provide an analysis of combination of emphasis areas, countermeasures and functional classes/facility types including a benefit cost ratio according to various embodiments of the present disclosure; and

FIG. 9 illustrates an example user interface of a decision support tool, the user interface configured to provide a visualization of a benefit cost analysis for combinations of emphasis area, countermeasures, and functional classes/facility types according to various embodiments of the present disclosure.

### DETAILED DESCRIPTION

In the following paragraphs, the embodiments are described in further detail by way of example with reference to the attached drawings. In the description, well known components, methods, and/or processing techniques are omitted or briefly described so as not to obscure the embodiments. As used herein, the “present disclosure” refers to any one of the embodiments described herein and any equivalents. Furthermore, reference to various feature(S) of the “present embodiment” is not to suggest that all embodiments must include the referenced feature(s).

Among embodiments, some aspects of the present disclosure are implemented by a computer program executed by one or more processors, as described and illustrated. As would be apparent to one having ordinary skill in the art, one or more embodiments may be implemented, at least in part, by computer-readable instructions in various forms, and the present disclosure is not intended to be limiting to a particular set or sequence of instructions executed by the processor.

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein, the terms “machine,” computer,” and “server” are not limited to a device with a single processor, but may encompass multiple devices (e.g., computers) linked in a system, devices with multiple processors, special purpose devices, devices with various peripherals and input and output devices, software acting as a computer or server, and combinations of the above.

The present disclosure describes systems and methods for strategic investment decisions on highway improvement projects. In various aspects, the systems and methods can include a decision support tool (also referred to as a “Strategic Investment Decisions for Highway Improvement Projects Tool” or “Hi-ImPct”) executable by at least one computing device to support strategic decision making by highway professionals and policy makers, and to provide an investment decision-making tool focusing on roadway improvement. In some embodiments, the decision support tool is a Microsoft® Excel® workbook embedded with functionality which includes a process of estimating the cost(s) of various roadway projects under specific strategies, and the benefit of reductions in the severity of crashes by implementing particular strategies on specific emphasis areas of a highway safety plan, for example, a jurisdiction (e.g., a state or region) specific Strategic Highway Safety Plan (SHSP). In some embodiments, the decision support tool can, for example, obtain crash data including locations of crashes and injury levels associated with the crashes. The crash data may include, for example. historical crash data, roadway inventory data, estimates for unit cost of improvements, high-quality Crash Modification Factors (e.g., from a CMF Clearinghouse), and the like. The decision support tool can advantageously provide features that can analyze or process the crash data. In some embodiments, the decision support tool can determine or document spatial assignments for the crashes based on a geographic information system (GIS) layer or other layer associated with a roadway or an intersection. A user can interact with a user interface to process the data, such as, for example, the frequency of crashes by fatal and serious injury levels within different functional classes of roadways, to select user interface elements, and to input data that is relevant to a specific safety project to be considered. In some embodiments, the user interface can render tables and visualizations to, for example, provide guidance to address systemwide safety problems in terms of fatalities and serious injuries by emphasis area in the highway safety plan, to provide an assessment of benefits in implementing safety projects on specific roadways to address safety issues by emphasis area against the cost of highway improvements, and to help understand what countermeasures are cost effective to address safety issues with fatalities and serious injuries by roadway class.

The disclosed decision support tool can be used to analyze a reduction in number of fatalities and serious injuries for one or more countermeasures for a roadway improvements project which can be used as a ‘benefit’ of implementing such countermeasures on a particular roadway, as can the ‘cost’ of the countermeasures which form part of the improved roadway projects. In some embodiments, these and other such indicators can be used to determine a key performance indicator such as, for example, a benefit-cost ratio, of a critical matrix. The decision support tool described herein can advantageously provide a data-driven process to help support the strategic decision making by highway professionals and policy-makers. The decision support tool can, for example, provide a systematic process that can link a key performance indicator such as the ‘benefit-cost ratio’ of competing projects to support strategic decision making.

In some embodiments the decision support tool can focus on roadway improvement, for example, the cost of project improvements under specific strategies can be estimated against the benefit of reductions in the severity of crashes by implementing particular strategies on specific Emphasis Areas in a highway safety plan (e.g., a jurisdiction specific Strategic Highway Safety Plan (SHSP)). The decision support tool can advantageously enable the flexibility to select strategies in different functional classes (or facility types) of roadway under one or more Emphasis Areas to yield cost effectiveness from the agency standpoint. It is critical for a particular jurisdiction to determine where the most return of safety benefit can be expected. As such, the decision support tool can focus on a jurisdiction's roadway system for relevant Emphasis Areas of the SHSP that will be highly impacted by highway improvement projects, with a target of reducing fatalities and serious injuries. In some embodiments, advantages of the disclosed decision support tool can include: (1) benefit-cost analysis at the roadway level functional class for Emphasis Areas of the SHSP can provide a clear picture of the return of benefits from the invested resources; (2) the effect of single or multiple countermeasures and the methodology to incorporate them into the benefit-cost analysis can provide insights to practitioners, safety engineers, and design engineers; (3) the decision support tool can allows additional (or new) countermeasures and their Crash Modification Factors (CMFs) to be added for future expansion; and (4) the decision support tool can incorporate visualization that can provide feedback to an informed decision-making process for policy-makers.

In some embodiments, the decision support tool can provide a quantitative approach (e.g., utilizing objective data built in to (or available to) the decision making tool) to support a decision-making process in the planning phase of project selection at the state, local, and regional levels. The decision support tool can be configured to, for example, align with Emphasis Areas identified in a highway safety plan (e.g., an SHSP), incorporate state-of-the-art from the latest safety management research (i.e., Crash Modification Factors (CMFs) and methods to address the impact of multiple safety improvements), allow for customization for changes in costs and Emphasis Areas. In some embodiments, the quantitative analysis of the decision support tool can provide directions to the policy makers (who can influence reductions in fatalities and serious injuries) as follows: (1) provide guidance to address system-wide safety problems in terms of fatalities and serious injuries by Emphasis Areas in an highway safety plan (e.g., an SHSP); (2) provide a clear assessment of benefits in implementing safety projects on specific roadways to address safety issues by Emphasis Areas against the cost of improvements; (3) help to understand what countermeasures are cost-effective to address safety issues of fatalities and serious injuries by roadway class; and (4) help to understand the benefit-cost analysis of implementing one countermeasure or multiple countermeasures along segment of roadway.

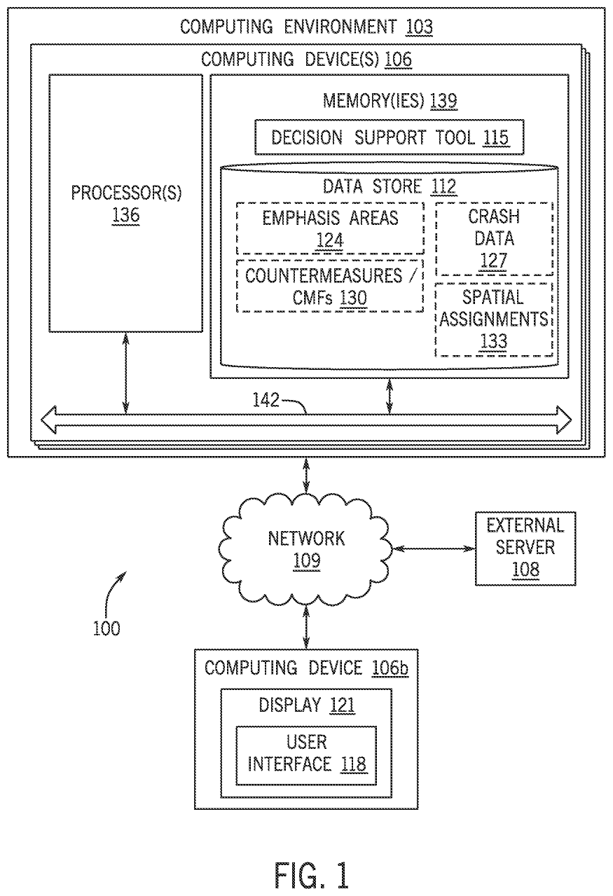

Turning to the drawings, FIG. 1 shows a networked environment 100 according to various embodiments. The networked environment 100 includes a computing environment 103, one or more computing devices 106, and an external server 108 in data communications via a network 109. The computing devices(s) 106 may comprise, for example, a server computer, a client computing device, or any other system providing computing capability. The network 109 includes, for example, the internet, intranets, extranets, wide area networks (WANs), local area networks (LANs), wired networks, wireless networks, cable networks, satellite networks, or other suitable networks, etc., or any other combination of two or more such networks. The external server 108 may be any computing device, computing environment, data provider, or service provider, which may be provided by a third-party or by the provided or computing environment 103.

Various applications and/or other functionality may be executed in the computing environment 103 according to various embodiments. Also, various data may be stored in a data store 112 that is accessible to the computing environment 103. The data store 112 may be representative of a plurality of data stores 112 as can be appreciated. The data stored in the data store 112, for example, is associated with the operation of the various applications and/or functional entities described below. The components executed on the computing environment 103, for example, include a predictive safety assessment tool 115, and other applications, services, processes, systems, engines, or functionality not discussed in detail herein.

As noted above, in some embodiments the decision support tool 115 may be executed to support strategic decision making by highway professionals and policy makers, and to provide an investment decision-making tool focusing on roadway improvement. The cost of project improvements under specific strategies can be estimated against the benefit of reductions in the severity of crashes by implementing particular strategies on specific emphasis areas, for example, the Emphasis Areas in a jurisdiction specific highway safety plan (e.g., an SHSP), The decision support tool 115 can enable the flexibility to select strategies in different functional classes of roadway under each Emphasis Areas to yield cost effectiveness from an agency standpoint. The decision support tool 115 can provide guidance to address systemwide safety problems in terms of fatalities and serious injuries by Emphasis Areas in, for example, a jurisdiction specific highway safety plan (e.g., an SHSP) based on the major functional classes of roadways (e.g., a state-specific SHSP may adopt an SHSP based on the national SHSP developed by American Association of State highway Officials (ASSHTO)).

Although not explicitly depicted in the example of FIG. 1, it is contemplated that the systems and method disclosed herein can be executed by one computing device 106, such as an analyst workstation, or any other system providing computing capability. According to an embodiment, one or more of the computing devices 106 (e.g., the computer device 106 and/or the computing device 106b) may be configured to execute various applications such as a client application to access network content served up by the predictive safety assessment tool 115, thereby rendering a user interface 118 on a display 121. A preferred embodiment of this disclosure can provide the predictive safety assessment tool 115 as a Microsoft® Excel® workbook embedded with functionality that can be implemented in Visual Basic®.

The display 121 may comprise, for example, one or more devices such as liquid crystal display (LCD) displays, gas plasma-based flat panel displays, organic light emitting diode (OLED) displays, electrophoretic ink (E ink) displays, LCD projectors, or other type of display devices, etc. In another example, it is contemplated that one of the computing devices 106 can execute the predictive safety assessment tool 115, and render user interface 118 on the display 121 of the computing device 106b.

The client application may comprise, for example, a browser, a dedicated application, etc., and the user interface 118 may comprise a network page, an application screen, etc. The computing device 106 may be configured to execute applications beyond the client application such as, for example, email applications, word processors, spreadsheets, traffic safety applications, and/or other applications.

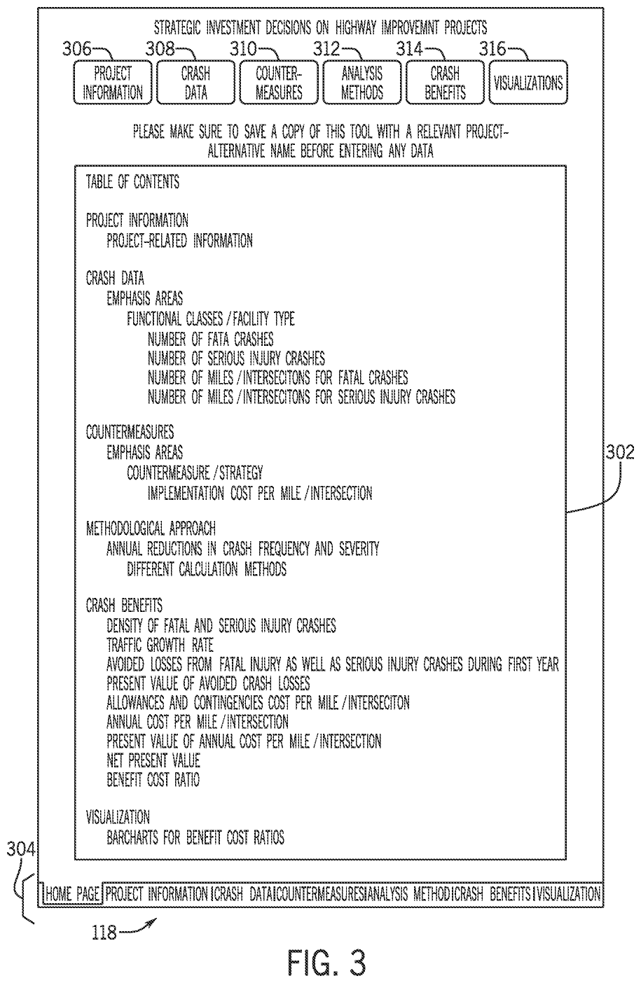

The user interface 118 may be dynamically updated to render one or more tables or visualizations, e.g., as shown in FIGS. 3-9. In some embodiments, the decision support tool 115 can inform the policymakers and highway safety engineers with a target to reduce roadway fatalities and serious injuries. For example, the user interface 118 can include drop-down menus and a selection process configured to allow user input while avoiding errors.

The decision support tool 115 can provide flexibility to select appropriate methodology of multiple countermeasures implementation to address fatal and serious injury crashes by functional class of roadways. The decision support tool 115 can also help to understand what countermeasures are cost-effective to address safety issues of fatalities and serious injuries by roadway class (e.g., with simplified graphs). In some embodiments, the decision support tool 115 can provide flexibility to include future CMFs and improvements cost of highway projects. The decision support tool 115 can allow practitioners and policy makers to focus on major elements of highway safety with up-to-date CMFs and cost of project information with a promise of greatest return from the investment (particularly addressing fatalities and serious injury crashes on roadways by functional class of roadways and intersection types).

The data stored in the data store 112 includes, for example, emphasis areas 124, crash data 127, countermeasures and/or crash modification factors (CMFs) 130, summary of spatial assignments 133, and potentially other data. The emphasis areas 124 can include data about definitions of emphasis areas of a highway safety plan or associated with the highway safety plan. The crash data 127 can include data about crashes (or crash events), including locations of the crashes, vehicles, occupants, injury levels (or severities), and the like, The crash data 127 can include an organization of the crashes by the emphasis areas 124.

The countermeasures and CMFs 130 can include data about countermeasures and CMFs for the emphasis areas 124. The summary of spatial assignments 133 can include data about geocoding of the crashes based, for example, on a geographic information system (GIS) layer or other layer associated with a roadway or intersection.

According to an embodiment of the present disclosure, each computing device 106 includes at least one processor circuit, for example, having a processor 136 and a memory 139, both of which are coupled to a local interface 142. To this end, each computing device 106 may comprise, for example, at least one server computer, personal computer, workstation, or like device. The local interface 142 may comprise, for example, a data bus with an accompanying address control bus or other bus structure as can be appreciated.

Stored in the memory 139 are both data and several components that are executable by the processor 136. In particular, stored in the memory 139 and executable by the processor 136 are the decision support tool 115, and potentially other applications. Also stored in the memory 139 may be the data store 112 and other data. In addition, an operating system may be stored in the memory 139 and executable by the processor 136.

It is understood that there may be other applications that are stored in the memory 139 and are executable by the processor 136 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby Flash®, or other programming languages.

A number of software components are stored in the memory 139 and are executable by the processor 136. In this respect, the term “executable” means a programmable file that is in a form that can ultimately be run by the processor 136. Examples of executable programs may be, for example, a compiled program that can be translated into machine code in a format that can be loaded into a random access portion of the memory 139 and run by the processor 136, source code that may be expressed in proper format such as object code that is capable of being loaded into a random access portion of the memory 139 and executed by the processor 136, or source code that may be interpreted by another executable program to generate instructions in a random access portion of the memory 139 to be executed by the processor 136, etc. An executable program may be stored in any portion or component of the memory 139 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 139 is defined herein as including both volatile and nonvolatile memory and data storage components. Volatile components are those that do not retain data values upon loss of power. Nonvolatile components are those that retain data upon a loss of power. Thus, the memory 139 may comprise, for example, random access memory (RAM), read-only memory (ROM), hard disk drives, solid-state drives, USB flash drives, memory cards accessed via memory card reader, floppy disks accessed via an associated floppy disk drive, optical discs accessible via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 136 may represent multiple processors 136 and/or multiple processor cores and the memory 139 may represent multiple memories 139 that operate in parallel processing circuits, respectively. In such a case, the local interface 142 may be an appropriate network that facilitates communication between any two of the multiple processors 136, between any processor 136 and any of the memories 139, or between any two of the memories 139, etc. The local interface 142 may comprise additional systems designed to coordinate this communication, including, for example, performance load balancing. The processor 136 may be of electrical or of some other available construction.

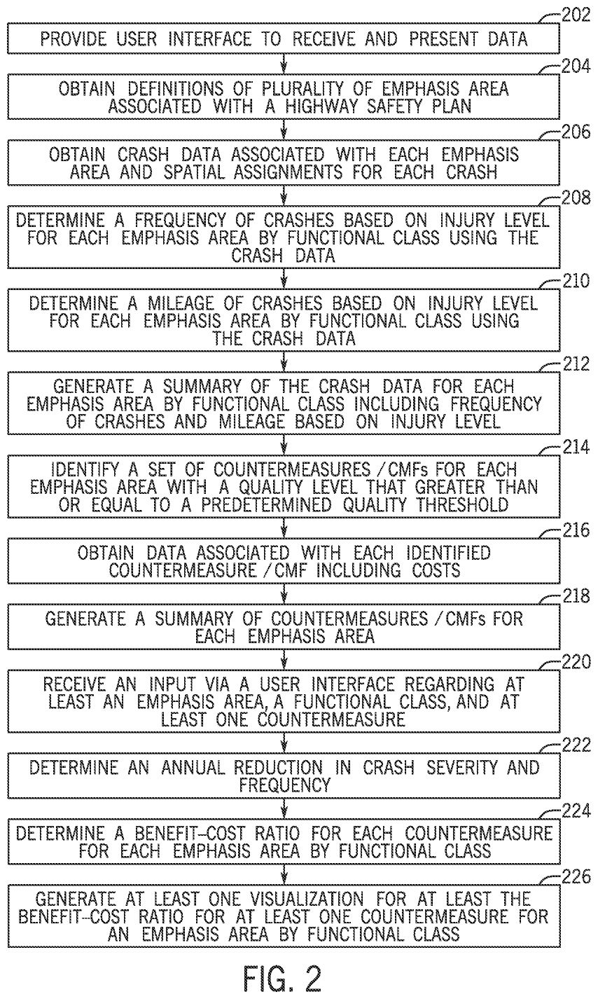

FIG. 2 illustrates a method for determining benefits and costs for a roadway improvement project using a decision support tool according to various embodiments of the present disclosure. FIG. 2 provides an example of the operations of portions of the decision support tool 115 (FIG. 1) according to various embodiments of the present disclosure. It is understood FIG. 2 provides an example of the decision support tool 115 as described herein. In some embodiments, the elements of the method illustrated in FIG. 2 may be implemented in the networked environment 100 (FIG. 1) according to one or more embodiments.

At block 202, the decision support tool 115 can provide or render a user interface(s) 118 to receive and present data (e.g., user interfaces 118 shown in FIGS. 3, 4, 7A-7E, and 8). In some embodiments, a user can input (via one or more user interfaces, e.g., as shown in one or more of FIGS. 3-9) with various user interface elements (e.g., text box, button, drop down menu, etc.) data and information such as, for example, project information, cost information, amount deployed, deployment mileage for improvement, service life in years, traffic growth rate, etc. At block 204, the decision support tool 115 may obtain definitions for a plurality of emphasis areas that are associated with a highway safety plan, for example, a Strategic Highway Safety Plan (SHSP) from, for example, memory 139 or an external server 108. In some embodiments, the high safety plan may be jurisdiction specific, for example, state, region, etc. In an embodiment, a jurisdiction specific SHSP may adopt an SHSP based on, for example, the national SHSP developed by American Association of State highway Officials (AS SHTO). Examples of emphasis areas include, but are not limited to, lane departure, impaired driving, pedestrians (signalized and un-signalized), bicyclists, intersections (signalized and un-signalized), motorcyclist, older driver, speeding and aggressiveness, trucks, young driver, distracted driver, and work zone. At block 206, the decision support tool can obtain crash data associated with each emphasis area and spatial assignments associated with each crash. In some embodiments, the crash data incudes historical crash data and roadway system (or inventory) data. The crash data may include, for example, data for a plurality of crashes (or crash events) including or not limited to, location of crash, vehicle(s), occupant(s), injury levels (i.e., severity, for example, fatal or severe injury), functional class of roadway/facility type, mileage, and the like. Examples of functional classes of roadways (or facility types) include, but are not limited to, principal arterial—interstate, principal arterial—expressway, principal arterial—other, minor arterial, major collector, minor collector, intersection type (e.g., 4-leg signalized intersection, 3-leg signalized intersection, 4-leg stop/yield/flashing intersection, 3-leg stop/yield/flashing intersection), and the like. In an embodiment, the spatial assignment for a crash can be data about geocoding of the crash based on, for example, a geographic information system (GIS) layer or other layer associated with a roadway or intersection. In some embodiments, the crash data and the spatial assignments can be retrieved from memory 139 or from an external server 108. In some embodiments, the crash data may be obtained or retrieved from a crash database, for example, a national or jurisdiction specific crash database in memory 139 or on an external server 108.

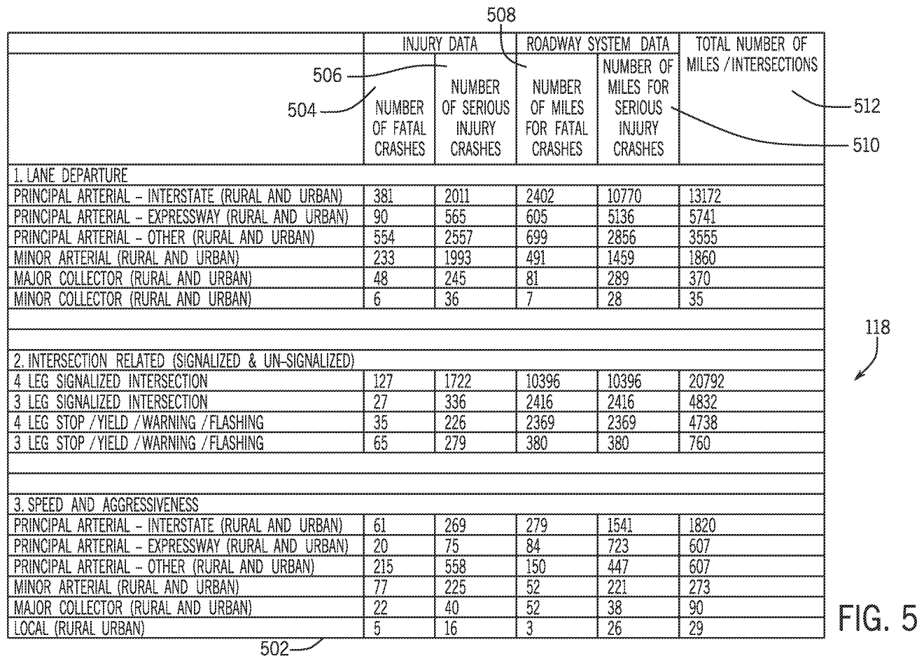

At block 208, a frequency of crashes based on injury level for each emphasis areas by functional class (or functional class of roadway) is determined based on the crash data. For example, the decision support tool 115 can determine the number of fatal crashes and the number of serious injury crashes for each specific emphasis area (e.g., lane departure) by functional classes (e.g., principal arterial—interstate, etc.) At block 210, a mileage of crashes based on injury level for each emphasis area by functional class using the crash data is determined based on the crash data. For example, the decision support tool 114 can determine a number of miles for fatal crashes and a number of miles for serious injury crashes for a specific emphasis area (e.g., lane departure) by functional classes (e.g., principal arterial—interstate, etc.). In some embodiments, the decision support tool 115 may also be configured to determine the total number of miles/intersections. At block 212, the decision support tool 115 can generate a summary of the crash data for each emphasis area by functional class including the frequency of crashes based on injury level and the mileage based on injury level. For example, the summary can be a table or other visualization such as discussed further below with respect to FIG. 5.

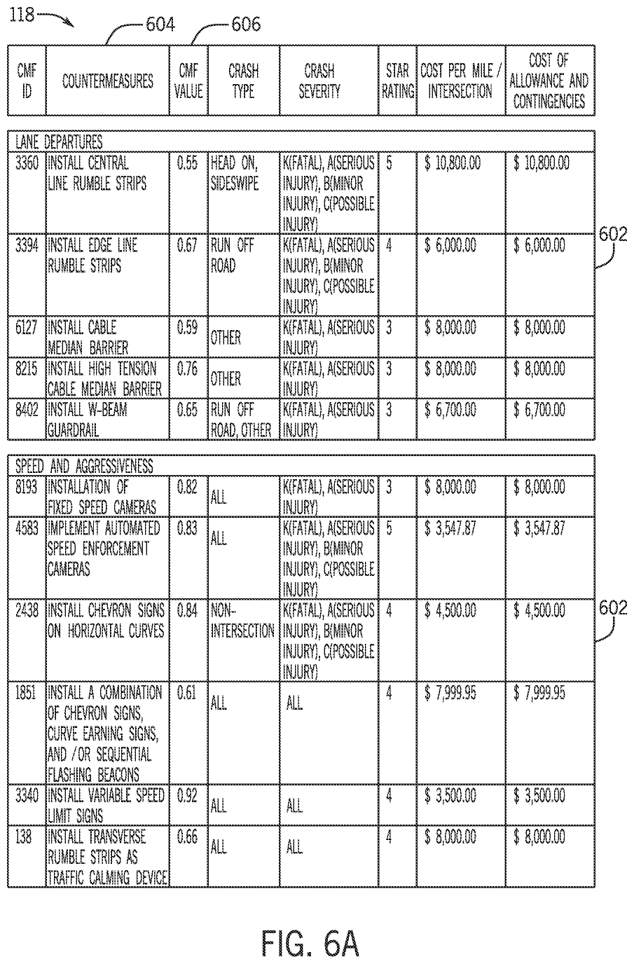

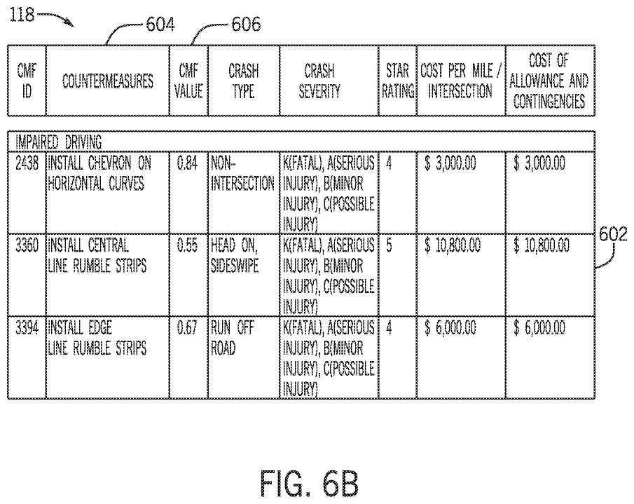

At block 214, the decision support tool 115 can identify a set of countermeasures and corresponding crash modification factors (CMFs) for each emphasis area that have a quality level that is greater than or equal to a predetermined quality threshold. For example, the quality level may be a star rating (e.g., from 1-5 stars) and the predetermined threshold may be a three (3) star rating. Accordingly, in some embodiments high-quality CMFs with a star rating greater than or equal to three can be identified to be analyzed by the decision support tool. In some embodiments, each CMF may be associated with a countermeasure and can indicate how much the given countermeasure can reduce the number of crashes. Examples of countermeasures include, but are not limited to, install central line rumble strips, install edge line rumble strips, install chevron on horizontal curves, install transverse rumble strips as traffic calming device, install pedestrian signals, install pedestrian hybrid beacon, install lighting, install raised median with or without marked crosswalk (uncontrolled), increase bike lane width, increase median width, dynamic signal warning flasher, improve signal control visibility, install traffic control, install intersection conflict warning system, improve pavement function, widen shoulder width, implement mobile automated speed enforcement system, install wider marking with resurfacing, install fixed speed cameras, install variable speed limit signs, install wider edge line (406 in.), install lane curve warning, pavement markings, install cable median barrier, install W beam guardrail, increase outside shoulder width inside work zone by 1 ft., and the like. In some embodiments, all of the countermeasures and CMFS may be considered and therefore, are not filtered by a quality level. At block 216, decision support tool 115 may obtain data associated with each identified countermeasure and corresponding CMF including costs. The data associated with the identified countermeasures and CMFs can include, for example, a CMF identifier, a crash type (e.g., head o, run off road, etc.), a crash severity (e.g., fatal, serious injury, minor injury, possible injury), star rating, cost per mile/intersection, and cost of allowances and contingencies. At block 218, the decision support tool 115 may generated a summary of the countermeasures, CMFS and other associated data for each emphasis area. For example, the summary can be a table or other visualization such as discussed further below with respect to FIG. 6.

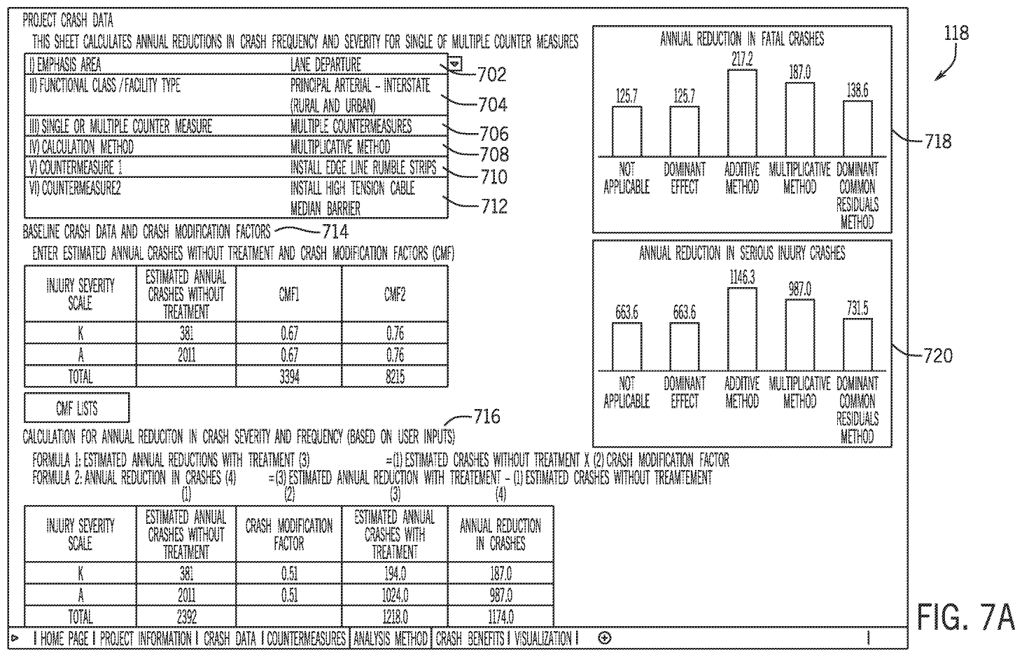

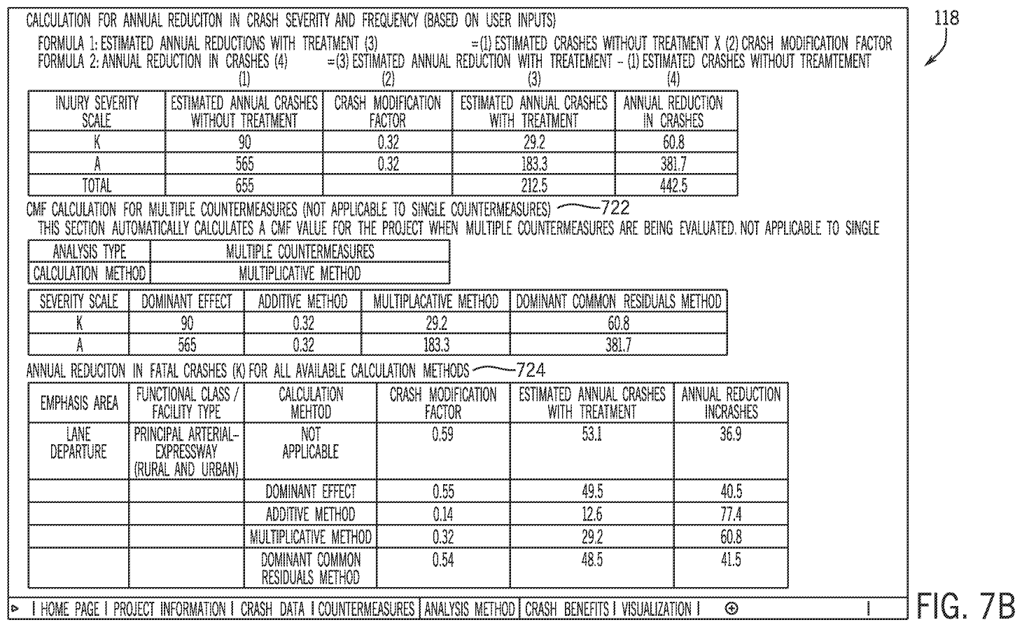

At block 220, the decision support tool 115 may receive input (e.g., user input via a user interface, for example, as shown in FIGS. 7A-7E discussed further below) regarding at least an emphasis area, a functional class, and at least one countermeasure. For example, a user may select these items via a user interface, for example, using a drop down menu or button. In some embodiments, a user may also select one of a plurality of analysis or calculation methods (e.g., dominant effect, additive method, multiplicative method, dominant common residual method) for determining an CMF when multiple countermeasures are selected and the user can select and estimated annual crashes without treatment for one or more injury levels. In some embodiments, the estimated annual crashes without treatment for one or more injury levels may be retrieved from a memory 139 or external server 108. At block 222, the decision support tool 115 can determine or calculate an annual reduction in crash severity and frequency for the selected combination of emphasis area, functional class, and countermeasure(s). In one embodiment, the annual reduction in crashes may be determined as the difference between the estimated annual reduction with treatment and the estimated crashes without treatment. The estimated annual reduction with treatment may be determined as the estimated crashes without treatment multiplied by the crash modification factor. In an embodiment where a single countermeasure is selected, the CMF is the CMF of the countermeasure. In an embodiment where multiple countermeasures are selected, the CMF may be determined by using the one or more of the CMF analysis (or calculation) methods and the CMF for each of the multiple countermeasures.

At block 224, the decision support tool 115 can determine a benefit cost ratio for each countermeasure for each emphasis areas by functional class. In some embodiments, the benefit cost ratio can be determined as:

$$Benefit Cost Ratio = \frac{Present Value of Avoided Crash Losses for Service Life}{Present Value of All Costs} \qquad Eq . 1$$

In some embodiments, the cost components used for the benefit cost analysis can include, for example, (a) number of mile or intersections for deployment of improvements (i.e., countermeasures); (b) annual cost per unit (miles of segment or number of intersections); and (c) initial cost. User input that may be used for benefit cost analysis can include, for example, deployment mileage for improvement, service life in years (treatment cost), and traffic growth (road system data). In some embodiments, a present value of annual costs can be determined as: Number of Miles or Intersections Considered for Deployment×Annual Cost Per Unit×(1−((1+Annual Discount Rate)^{-Service Life in Years})/Annual Discount Rate. In some embodiments, the present value of all costs can be determined as: Initial Cost+Present Value of Annual Costs. In some embodiment, for the benefit components of the benefit cost analysis, a Net Present Value can be determined as: Present Value of Avoided Crashes Losses for Service Life−Present Value of All Costs. In some embodiments, an Avoided Crash Losses in First Year KA can be determined as:

$$\frac{Fatal Crashes + Serious Imjury Crashes}{Total Miles or Intersections for Fatal and Serious Injury Crashes} \times \frac{( Deployment Milage for Improvement )}{Number of Years of Crash Data} \times ( 1 - CMF ) \times ( Comprehensive Crash Unit for Combined KA Crashes ) .$$

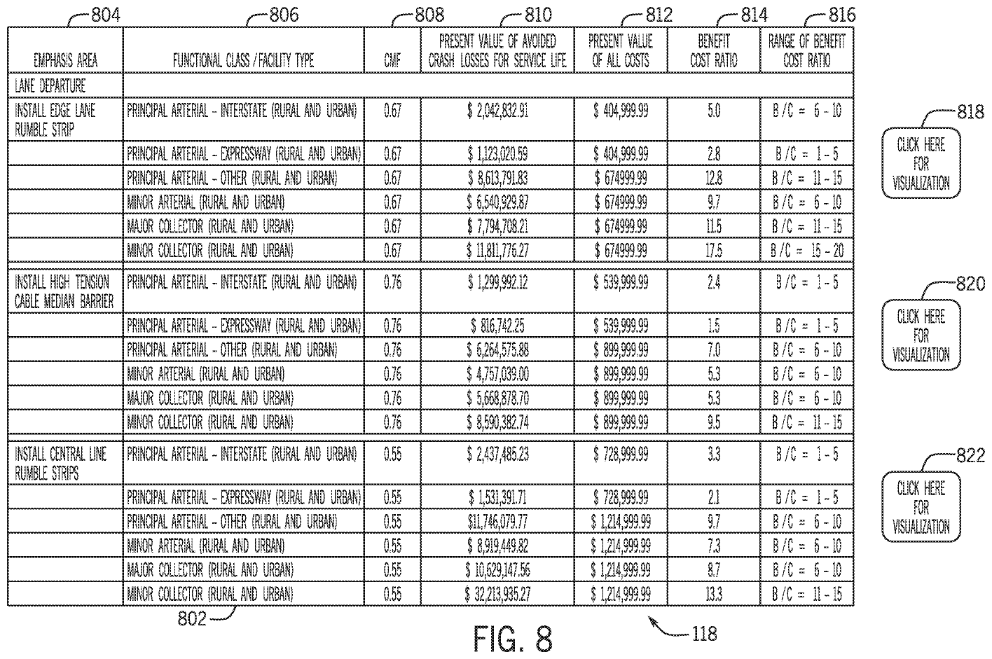

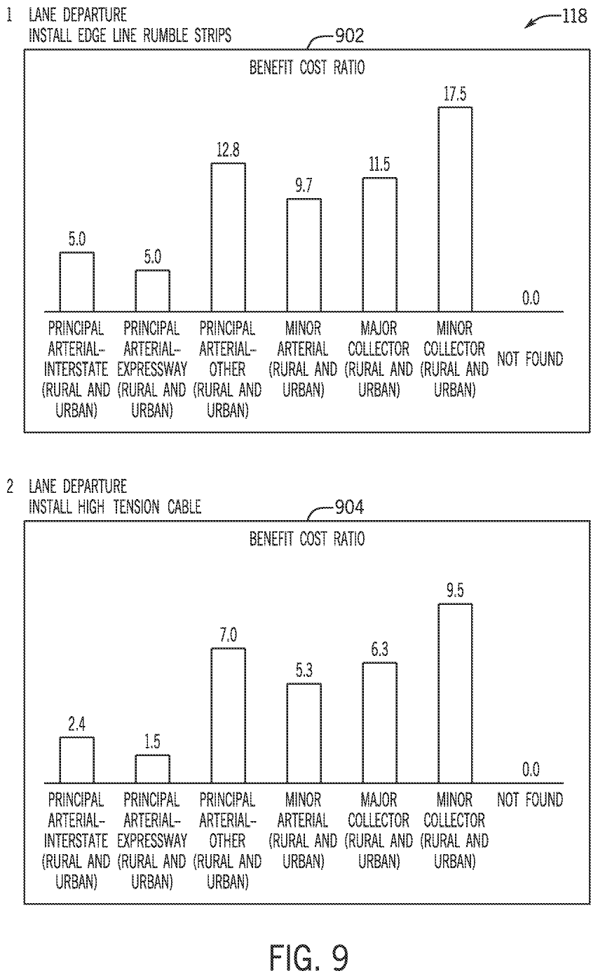

In addition, in some embodiments each countermeasure for each emphasis area and a functional class (or facility type) can be assigned a range of benefit cost ratio based on the benefit cost ratio determined for the countermeasure. For example, in some embodiments a first range of benefit cost ratio can be 1-5, a second range of benefit cost ratio can be 6-10, a third range, and so on. At block 226, the decision support tool 115 can generate at least one visualization for at least one of the benefit cost ratio for at least one countermeasure for an emphasis areas by functional class. For example, a table or graph may be generated to illustrate the benefit cost ratio and other data associated with each countermeasure for an emphasis areas by functional class. Example user interfaces providing visualizations for the benefit cost ratios and other data associated with a countermeasure for an emphasis area are discussed further below with respect to FIGS. 8 and 9.

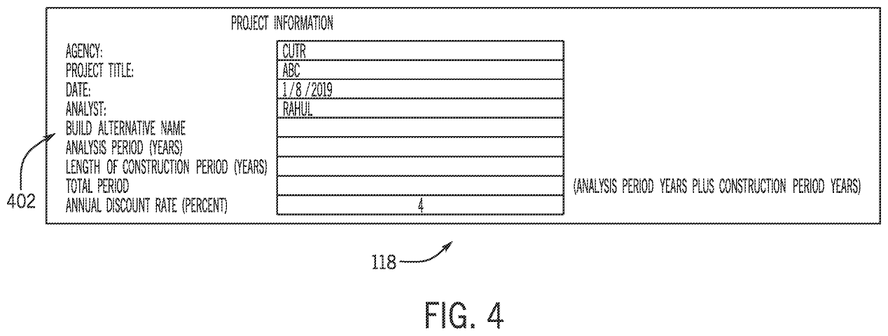

FIGS. 3-9 illustrate examples of user interfaces 118 rendered in the networked environment of FIG. 1 according to various example embodiments of the present disclosure. Any of the user interfaces 118 shown in FIGS. 3-9 can, for example, be rendered on the display 121 of the computing device 106b (FIG. 1). FIG. 3 illustrates an example user interface of a decision support tool according to various embodiments of the present disclosure. In FIG. 3, the user interface 118 is an example “home page” that provides a navigation menu and includes a table of contents 302, a plurality of tabs 306 to access each user interface (e.g., a worksheet) of the decision support tool. In the example of FIG. 3, the user interface 118 includes tabs 306 for home page, project information (FIG. 4), crash data (FIG. 5), countermeasures (FIGS. 6A-6B), analysis method (FIGS. 7A-7E), crash benefits (FIG. 8) and visualization (FIG. 9). The example user interface 118 may also include user interface elements, for example, in the form of button 306, 308, 310, 312, 314, and 316, to allow the user to select one of the other features of the decision support tool 115.

FIG. 4 illustrates and example user interface of decision support tool, the user interface configured to receive and display project information for a roadway project according to various embodiments of the present disclosure. In FIG. 4, the user interface 118 is configured to receive user input regarding project related data for the roadway improvement project for hic the user is conducting the benefit cost analysis. For example, the project data may be provided by a user via a plurality of text fields or boxes 402. The project data may include, for example, agency (e.g., the name of the transportation agency conducting benefit cost analysis), project title, date of analysis, analyst (e.g., the name of the analyst conducting the benefit cost analysis), analysis period (length of analysis period in years), and length of construction period (years).

FIG. 5 illustrates an example user interface of a decision support tool, the user interface configured to provide crash data for emphasis areas and functional classes/facility type according to various embodiments of the present disclosure. In FIG. 5, the example user interface 118 includes a table 502 that provides a summary of the crash data (e.g., obtained at block 206 of FIG. 2) for each emphasis area of a plurality of emphasis areas (e.g., lane departure, intersection related (signalized and un-signalized, speed and aggressiveness) by functional class (e.g., principal arterial—interstate (Rural and Urban), 4-Leg signalized intersection, minor arterial (Rural and Urban), etc.). As discussed above, the emphasis areas may be determined based on a highway safety plan (e.g., an SHSP). While user interface 118 shows three emphasis areas, it should be understood that in some embodiments more or fewer emphasis areas may be included in the summary table 502. The table 502 can include injury data for each emphasis area by functional class, for example, number of fatal crashes 504 and number of serious injury crashes 506. In addition, the table 502 can include roadway system data for each emphasis area by functional class, for example, number of mules for fatal crashes 508 and number of miles for serious injury crashes 510. Table 502 also includes data regarding the total number of mules/intersection 512,

FIGS. 6A and 6B illustrate an example use interface of a decision support tool, the user interface configured to provide information regarding countermeasures according to various embodiments of the present disclosure. In some embodiments, the example user interfaces 118 shown in FIGS. 6A and 6B may be combined and shown as a single user interface (e.g., a single worksheet) but are shown separately for simplicity and clarity. In FIGS. 6A and 6B, the example user interface 118 includes a table 602 that provides a summary of the countermeasures, the corresponding CMFs (CMF value 606), for example, the countermeasures and CMFs identified at block 214 of FIG. 2 based on a quality threshold, as well as other data related to the countermeasures 602 and CMFs 606. The table 602 can summarize the countermeasures 604 and CMFs 606 for each emphasis area of a plurality of emphasis areas (e.g., lane departure, speed and aggressiveness, impaired driving). While user interface 118 shows three emphasis areas, it should be understood that in some embodiments more or fewer emphasis areas may be included in the summary table 602. The table 202 can also include other data associated with each countermeasure for each emphasis area such as, for example, a CMF identifier (ID), crash type, crash severity, a quality level (e.g., a star rating), cost per unit intersection, and cost of allowance and contingencies.

FIGS. 7A and 7B illustrate example user interfaces of a decision support tool, the user interfaces configured to receive input and display an analysis of combinations of emphasis areas, countermeasures and functional classes/facility types for a roadway project according to various embodiments of the present disclosure. FIGS. 7A-7B can be seen as examples of the decision support tool 115 generating a portion of the user interface 118 that is an input sheet configured to obtain user input and that is configured to provide analysis regarding an annual reduction in crash severity for a selected combination of emphasis area, functional class and one or more countermeasures. In FIG. 7A, in some embodiments, the user interface 118 includes input elements, for example, drop down menus, to receive a user selection of an emphasis area 702, a functional class 704, a single or multiple countermeasure 706, a calculation method 708 (e.g., for determining an CMF when multiple countermeasures are selected), a first countermeasure 710 and a second countermeasure 712. In some embodiments, the calculation method can be, for example, a dominant effect, an additive method, a multiplicative method, a dominant common residual method or the like. In the example of FIG. 7A, the selected items are: (1) emphasis area 702 is lane departure, (2) the selected functional class 704 is principal arteries—interstate, (3) multiple countermeasures 706, (4) a multiplicative method 708 to determine or calculate a CMF for multiple countermeasures, (5) the first selected countermeasure 710 is “install edge line rumble strips”, (6) the second selected countermeasure 712 is “install high tension cable median barrier.” The user interface 118 can also be configured to provide baseline crash data and crash modification factors 713. In some embodiments, some of the baseline crash data and CMFs may be provided by a user interacting with the user interface 118, for example, using a text box. In some embodiments, the user interface 118 may be configured to provide a calculation of annual reduction in crash severity and frequency 716. As discussed above with respect to block 220 of FIG. 2, the decision support tool 115 can determine or calculate an annual reduction in crash severity and frequency for the selected combination of emphasis area, functional class, and countermeasure(s). In one embodiment, the annual reduction in crashes may be determined as the difference between the estimated annual reduction with treatment and the estimated crashes without treatment. The estimated annual reduction with treatment may be determined as the estimated crashes without treatment multiplied by the crash modification factor. In the example embodiment of FIG. 7A, where multiple countermeasures are selected, the CMF may be determined by using the one or more of the CMF analysis (or calculation) methods and the CMF for each of the multiple countermeasures. In an embodiment where a single countermeasure is selected, the CMF is the CMF of the countermeasure. In some embodiments, the decision support tool can provide a visualization of the annual reduction in crashes by injury level (or severity) and, for one or more of the calculation methods. For example, in FIG. 5 a bar chart 718 illustrates calculated annual reduction in fatal crashes and bar chart 720 illustrates calculated annual reduction in serious injury crashes.

In FIG. 7B, in some embodiments, the user interface 118 can be configured to provide data and information regarding additional CFM and annual reduction in fatal crashes. For example, a CMF calculation for multiple countermeasures 722 is illustrated and may be determined for one or more of the calculation (or analysis) methods. In addition, a determination of annual reduction in fatal crashes for all available calculation methods can be provided and a determination of an annual reduction in Serious crashes for all available calculation methods (not shown in FIG. 7B) can be provided on the user interface 115.

FIG. 8 illustrates an example user interface of a decision support tool, the user interface configured to provide an analysis of combination of emphasis areas, countermeasures and functional classes/facility types including a benefit cost ratio according to various embodiments of the present disclosure. As mentioned above, the decision support tool 115 can generate at least one visualization for at least one of the benefit cost ratio for at least one countermeasure for an emphasis area by functional class. In FIG. 8, the example user interface 118 includes a table 802 that provides a summary of data associated with crash benefits and costs for at least one countermeasure for each an emphasis area 804 (e.g., lane departure) by functional class 806 (e.g., principal arterial—interstate (Rural and Urban), minor arterial (Rural and Urban), etc.). While user interface 118 shows one emphasis area 804 and the crash benefit and cost data and information for the associated countermeasures, it should be understood that in some embodiments more than one emphasis area and the associated countermeasures for the emphasis areas may be included in the summary table 802. In the example summary shown in FIG. 8, the table 802 also includes a CMF value 808 for each countermeasure by functional class, a present value of avoided crash losses for service life 810 for each countermeasure by functional class, a present value of all costs 812 for each countermeasure by functional class, a benefit cost ratio 814 for each countermeasure by functional class, and a range of benefit cost ratio 816 for each countermeasure by functional class. As mentioned above, in some embodiments a benefit cost ratio for a countermeasure may be determined using Equation 1 as the ratio of present value of avoided cash losses for service life to present value of all costs. In addition, in some embodiments each countermeasure for each emphasis area and a functional class (or facility type) can be assigned a range of benefit cost ratio 816 based on the benefit cost ratio determined for the countermeasure. For example, in some embodiments a first range of benefit cost ratio can be 1-5, a second range of benefit cost ratio can be 6-10, a third range, and so on. In some embodiments, each benefit cost range can also be represented by a different color. In some embodiments, the summary table 802 can include other data and information (not shown for simplicity and clarity) for each countermeasure for an emphasis area by functional class including, but not limited to fatal crash (K) number, serious injury crash (A) number, mileage/number of intersections for fatal crashes, mileage/number of intersections for serious crashes, years of crash data, total mileage, deployment mileage for improvement, crash density, service life in years (treatment cost), traffic growth rate (road system data), avoided crash losses in first year, unit cost, unit (e.g., miles), allowances and contingencies per unit, annual cost per unit, amount deployed, initial cost, present value of annual costs, net present value, and the like.

In FIG. 8, the user interface 118 can also include an user interface element such as a button, to allow a user to select to have the decision support tool 115 generate a visualization of, for example, the benefit cost ratios 814 for a countermeasure for an emphasis area by functional class. For example, for the emphasis area “lane detection,” a button 818 may be provided to allow a user to request a visualization for the countermeasure “install edge lane rumble strip” by functional class, a button 820 may be provided to allow a user to request a visualization for the countermeasure “install high tension cable median barrier” by functional class, and a button 822 may be provided to allow a user to request a visualization of the countermeasure “install central line rumble strips” by functional class. FIG. 9 illustrates an example user interface of a decision support tool, the user interface configured to provide a visualization of a benefit cost analysis for combinations of emphasis area, countermeasures, and functional classes/facility types according to various embodiments of the present disclosure. In the example of FIG. 9, a visualization of a benefit cost ration for two countermeasures for an emphasis areas by functional class is shown. In this example, the emphasis area is “lane departure.” A first bar graph 902 is shown for the benefit cost ratios for the countermeasure “install edge line rumble strip” for each functional class (e.g., principal arteria—interstate (Rural and Urban), major collector (Rural and Urban),etc.). A second bar graph is shown for the countermeasure “install high tension cable” for each functional class (e.g., principal arteria—interstate (Rural and Urban), major collector (Rural and Urban), etc.).

Although the decision support tool 115 and other various systems described herein may be embodied in software or codes executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuit (ASICs) having appropriate logic gates, field-programmable gate arrays (FPGAs), or other components, etc. Such technologies are generally well known to those skilled in the art and, consequently, are not described in detail herein.

Although embodiments have been described herein in detail, the descriptions are by way of example. The features of the embodiment described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded to the broadest interpretation so as to encompass modifications and equivalent structures.

What is claimed is:

1. A system for analyzing benefits and cost for a roadway improvement project, the system comprising:
at least one processor; and
a non-transitory computer-readable medium in communication with the at least one processor, wherein the at least one processor is configured to execute instructions embodied in the computer-readable medium to perform operations comprising:
obtaining definitions of a plurality of emphasis areas associated with a highway safety plan;
obtaining crash data associated with each of the plurality of emphasis areas, the crash data comprising a plurality of crashes, a location of each crash, functional class associated with each crash, and injury levels associated with each crash;
obtaining spatial assignments for each crash in the plurality of crashes;
determining a frequency of crashes for fatal and serious injury crash levels for each emphasis area by functional class based on the crash data associated with each emphasis area;
determining a mileage of crashes for fatal and serious injury crash levels for each emphasis area by functional class based on the crash data associated with each emphasis area;
determining at least one estimate of change in crashes expected after implementation of at least one countermeasure of a plurality of countermeasures, wherein each emphasis area is associated with a set of countermeasures from the plurality of countermeasures;
determining a plurality of costs associated with the plurality of countermeasures;
determining, for each emphasis area, a benefit cost ratio for each countermeasure in the set of countermeasures associated with the emphasis area; and
generating a user interface configured to render at least one of a table or a visualization based at least in part on at least one emphasis areas, the set of countermeasures associated with the at least one emphasis area, and the benefit cost ratio associated with the at least one countermeasure.

2. The system according to claim 1, wherein the highway safety plan is a jurisdiction specific strategic highway safety plan (SHSP).

3. The system according to claim 1, wherein the spatial assignments are based at least on a geographic information system (GIS) layer.

4. The system according to claim 1, wherein the at least one estimate of change in crashes expected after implementation of at least one countermeasure is an annual reduction in crash severity and frequency.

5. The system according to claim 1, further comprising generating a user interface configured to provide a summary of the crash data for each emphasis area by functional class.

6. The system according to claim 5, wherein the summary of the crash data includes the frequency of crashes for fatal and serious injury crash levels for each emphasis area by functional class and mileage of crashes for fatal and serious injury crash levels for each emphasis area by functional class.

7. The system according to claim 1, wherein determining at least one estimate of change in crashes expected after implementation of at least one countermeasure is based on a plurality of countermeasures, a plurality of crash modification factors (CMFs) having a quality level greater than or equal to a predetermined quality threshold and corresponding to the plurality of countermeasures, and at least one analysis method.

8. The system according to claim 7, wherein the at least one analysis method comprises at least one of: a dominant effect method, an additive method, a multiplicative method or a dominant common residual method.

9. The system according to claim 1, wherein the plurality of costs includes at least cost estimates to implement at least one of the plurality of countermeasures.

10. The system according to claim 1, wherein determining, for each emphasis area, a benefit cost ratio for each countermeasure in the set of countermeasures associated with the emphasis area comprises determining a ratio of a present value of avoided cash losses for service life to a present value of all costs.

11. A method analyzing benefits and cost for a roadway improvement project, the method comprising:
obtaining, via at least one computing device, definitions of a plurality of emphasis areas associated with a highway safety plan;
obtaining, via the at least one computing device, crash data associated with each of the plurality of emphasis areas, the crash data comprising a plurality of crashes, a location of each crash, functional class associated with each crash, and injury levels associated with each crash;
obtaining, via the at least one computing device, countermeasure and Crash Modification Factor (CMF) data associated with each emphasis area;
obtaining, via the at least one computing device, spatial assignments for each crash in the plurality of crashes;
determining, via the at least one computing device, a frequency of crashes for fatal and serious injury crash levels for each emphasis area by functional class based on the crash data associated with each emphasis area;
determining, via the at least one computing device, a plurality of costs associated with each countermeasure in the countermeasure and CMF data;
determining, for each emphasis area, via the at least one computing device, a benefit cost ratio for each countermeasure in the countermeasure and CMF data associated with the emphasis area;
generating, via the at least one computing device, a first user interface configured to render at least one of a table or a visualization based at least on at least one emphasis area, the set of countermeasures associated with the at least one emphasis area, and the benefit cost ratio associated with the at least one countermeasure.

12. The method according to claim 11, further comprising:
generating, via the at least one computing device, a second user interface configured to obtain a selection comprising at least an emphasis area element, a functional class element, and a countermeasures element; and
calculating, via the at least one computing device, an annual reduction in crash severity and frequency based at least on the selection of the emphasis area element, the functional class element and the countermeasures element, the definition associated with the emphasis element selection, the crash data associated with the emphasis element selection by functional class, and countermeasures and CMFs data associated with the emphasis element selection by functional class.

13. The method according to claim 12, wherein the second user interface is further configured to render a visualization for a plurality of analysis methods comprising a dominant effect method, an additive method, a multiplicative method, and a dominant common residual method.

14. The method according to claim 11, wherein obtaining countermeasure and CMF data associated with each emphasis area comprises identifying a set of countermeasure and CMF data wherein each CMF in the set of countermeasure and CMF data has a quality level that is greater than or equal to a predefined quality threshold.

15. The method according to claim 11, wherein the highway safety plan is a jurisdiction specific strategic highway safety plan (SHSP).

16. The method according to claim 11, further comprising generating a third user interface configured to provide a summary of the crash data for each emphasis area by functional class.

17. The method according to claim 16, wherein the summary of the crash data includes the frequency of crashes for fatal and serious injury crash levels for each emphasis area by functional class and mileage of crashes for fatal and serious injury crash levels for each emphasis area by functional class of roadways.

18. The method according to claim 11, wherein the plurality of costs includes at least cost estimates to implement at least one of the plurality of countermeasures.

19. The method according to claim 11, wherein determining, for each emphasis area, a benefit cost ratio for each countermeasure in the countermeasure and CMF data associated with the emphasis area comprises determining a ratio of a present value of avoided cash losses for service life to a present value of all costs.
